(19) United States
(12) Patent Application Publication
(10) Pub. No.: US 2013/0346317 A1
(43) Pub. Date: Dec. 26, 2013

(54) Personal Communications Applications, Devices and Systems

(71) Applicant: Tareq Augustino Korkis, Chicago, IL (US)

(72) Inventor: Tareq Augustino Korkis, Chicago, IL (US)

(21) Appl. No.: 13/533,705

(22) Filed: Jun. 26, 2012

(51) Int. Cl. G06Q 20/22; G06Q 40/00; G07B 15/02; G06Q 20/40

(52) U.S. Cl. 705/67; 705/65; 705/31; 705/13

(57) ABSTRACT

A client device may receive an offer from a tandem device. The offer may include an indication of a location and a cost. In response to receiving the offer, the client device may display a representation of the offer. The client device may receive acceptance of the offer. In response to receiving the acceptance of the offer, the client device may transmit an indication of the acceptance to the tandem device. The indication may include an encrypted payment token, and the encrypted payment token may include an encrypted instruction to (i) debit a first account associated with the client device based on the cost, and (ii) credit a second account associated with the tandem device based on the cost.

### BACKGROUND

In both small and large countries, government can be multi-leveled and bureaucratic. For example, in the United States, individuals and businesses contend with federal, state, county, and city governments, as well as other governmental agencies and bodies. From time to time, these individuals and businesses are required to communicate with these various levels of government. However, duplicated effort is often required to report these personal and business transactions to multiple governmental entities.

### SUMMARY

In a first example embodiment, a client device may receive, from a tandem device, an offer. The offer may include an indication of a location and a cost. In response to receiving the offer, the client device may display a representation of the offer. The client device may receive acceptance of the offer. In response to receiving the acceptance of the offer, the client device may transmit an indication of the acceptance to the tandem device. The indication may include an encrypted payment token, and the encrypted payment token may include an encrypted instruction to (i) debit a first account associated with the client device based on the cost, and (ii) credit a second account associated with the tandem device based on the cost.

In a second example embodiment, a tandem device may broadcast an offer. The offer may include an indication of a location and a cost. The tandem device may receive, from a client device, an acceptance of the offer and an encrypted payment token. The encrypted payment token may include an encrypted instruction to (i) debit a first account associated with the client device by the cost, and (ii) credit a second account associated with the tandem device based on the cost. In response to receiving the acceptance of the offer, the tandem device may transmit a verification request to a computing system. The verification request may include indications of the location, the cost, and the encrypted payment token. In response to receiving a payment verification from the computing system, the tandem device may transmit the payment verification to the client device. The payment verification may verify a payment associated with the verification request.

In a third example embodiment, a computing system may receive a representation of a transaction from a tandem device. The transaction may have occurred between a client device and the tandem device, and may be associated with a cost. The computing system may determine that the cost includes a service cost and a tax cost. In response to determining that the cost includes a service cost and a tax cost, the computing system may (i) debit the cost from a first account associated with the client device, (ii) credit the service cost to a second account associated with the tandem device, (iii) credit the tax cost to a third account associated with the tandem device, and (iv) report the tax cost to a governmental entity. In this way, it may be possible to enable real-time payment and reporting of the tax cost to the governmental entity.

A fourth example embodiment may include a non-transitory computer-readable storage medium, having stored thereon program instructions that, upon execution by a computing device, cause the computing device to perform operations in accordance with the first, second, and/or third example embodiments.

A fifth example embodiment may include a computing device, comprising at least a processor and data storage. The data storage may contain program instructions that, upon execution by the processor, cause the computing device to perform operations in accordance with the first, second, and/or third example embodiments.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1 depicts a distributed computing architecture, in accordance with an example embodiment.

FIG. 2 depicts a block diagram of a computing device, in accordance with an example embodiment.

FIGS. 3A, 3B, 3C, and 3D depict devices operating various personal communication applications, in accordance with example embodiments.

FIG. 4 depicts a communication architecture, in accordance with an example embodiment.

FIG. 5 depicts logical relationships between entities, in accordance with an example embodiment.

FIG. 6 depicts a transaction, in accordance with an example embodiment.

FIG. 7 depicts another transaction, in accordance with an example embodiment.

FIG. 8 depicts distribution of tax costs associated with a transaction, in accordance with an example embodiment.

FIG. 9 is a flow chart, in accordance with an example embodiment.

FIG. 10 is a flow chart, in accordance with an example embodiment.

FIG. 11 is a flow chart, in accordance with an example embodiment.

### DETAILED DESCRIPTION

### 1. Overview

The embodiments disclosed herein may provide simpler, centralized electronic access to multiple levels of government. Through the use of dedicated, personal communication applications and/or devices, an individual or business may have a single point of communication with various levels of government, various branches of government within these levels, and many (or all) government services. Possibly instead of using postal mail, fax, or telephone, users of these personal communication applications and/or devices may communicate electronically with virtual any governmental agencies in a secure fashion. Thus, use of these applications and/or devices may reduce the clutter of governmental paperwork that gets sent to individuals and businesses, which may be in accordance with numerous governments' “green” initiatives.

Additionally, personal communication applications and/or devices may be able to securely identify an individual and/or the individual's registered vehicles (e.g., cars, trucks, motorcycles, boats, planes, etc.). Thus, they may replace physical passports, driver's licenses, social security cards, hunting licenses, and other forms of personal identification. They may also obviate the need for physical registration stickers and/or parking stickers on vehicles. In some embodiments, these personal communication applications and/or devices may support real-time tax payments and tax reporting, as well as real-time identification verification functions to various governmental entities.

Further, personal communication applications and/or devices may also enable interactions with private entities that may require payment or a form of customer verification, such as parking garages, gas stations, and hotels. For instance, a personal communication device may be associated with an account, such as a debit account, a credit card account, or a bank account. When a vehicle bearing a device operating an appropriate personal communication application is parked at a parking garage, the vehicle owner may authorize the parking garage to debit the parking fee from the account. Additionally, these applications and/or devices may facilitate real-time tax reporting and homeland security verification functions.

It should be understood that the descriptions above are for purposes of example, and are not intended to be limiting. Personal communication applications may be used for many other purposes.

### 2. Example Communication System and Device Architecture for Supporting Personal Communication Applications

The methods, devices, and systems described herein can be implemented using client devices and/or so-called “cloud-based” server devices. In some situations, client devices may communicate directly with server devices owned and/or operated by a governmental entity. In other situations, the governmental entity may contract with private entities to own and/or operate server devices that are used for governmental functions.

Under various aspects of this paradigm, client devices, such as mobile phones and tablet computers, may offload some processing and storage responsibilities to remote server devices. At least some of the time, these client services are able to communicate, via a network such as the Internet, with the server devices. As a result, applications that operate on the client devices may also have a persistent, server-based component. Nonetheless, it should be noted that at least some of the methods, processes, and techniques disclosed herein may be able to operate entirely on a client device or a server device.

This section describes general system and device architectures for such client devices and server devices. However, the methods, devices, and systems presented in the subsequent sections may operate under different paradigms as well. Thus, the embodiments of this section are merely examples of how these methods, devices, and systems can be enabled.

A. Communication System

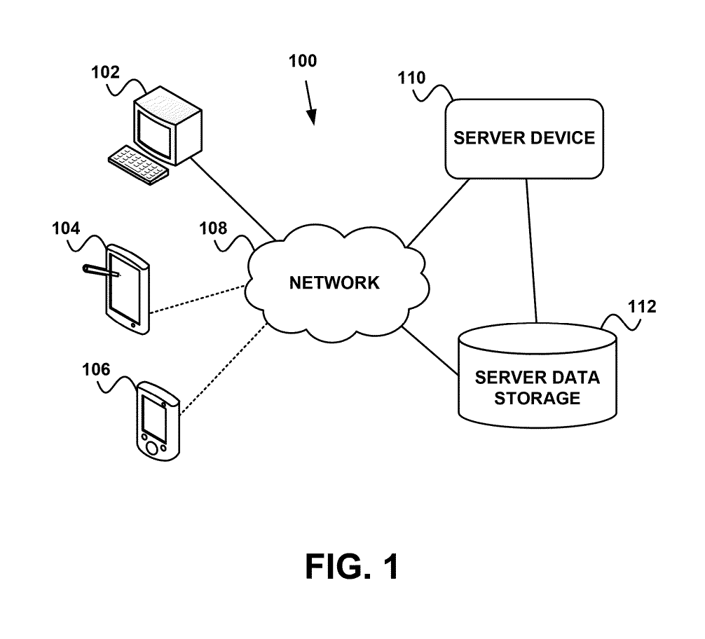

FIG. 1 is a simplified block diagram of a communication system 100, in which various embodiments described herein can be employed. Communication system 100 includes client devices 102, 104, and 106, which represent a desktop personal computer (PC), a tablet computer, and a mobile phone, respectively. Each of these client devices may be able to communicate with other devices via a network 108 through the use of wireline connections (designated by solid lines) and/or wireless connections (designated by dashed lines).

These client devices may be provided to individuals, businesses, or other entities by a governmental entity. Alternatively, the governmental entity may contract with a private entity for provision of the client devices.

Network 108 may be, for example, the Internet, or some other form of public or private Internet Protocol (IP) network. Thus, client devices 102, 104, and 106 may communicate using packet-switching technologies. Nonetheless, network 108 may also incorporate at least some circuit-switching technologies, and client devices 102, 104, and 106 may communicate via circuit switching alternatively or in addition to packet switching.

A server device 110 may also communicate via network 108. Particularly, server device 110 may communicate with client devices 102, 104, and 106 according to one or more network protocols and/or application-level protocols to facilitate the use of network-based or cloud-based computing on these client devices. Server device 110 may include integrated data storage (e.g., memory, disk drives, etc.) and may also be able to access a separate server data storage 112. Communication between server device 110 and server data storage 112 may be direct, via network 108, or both direct and via network 108 as illustrated in FIG. 1. Server data storage 112 may store application data that is used to facilitate the operations of applications performed by client devices 102, 104, and 106 and server device 110.

Although only three client devices, one server device, and one server data storage are shown in FIG. 1, communication system 100 may include any number of each of these components. For instance, communication system 100 may comprise millions of client devices, thousands of server devices and/or thousands of server data storages. Furthermore, client devices may take on forms other than those in FIG. 1.

B. Example Computing Device

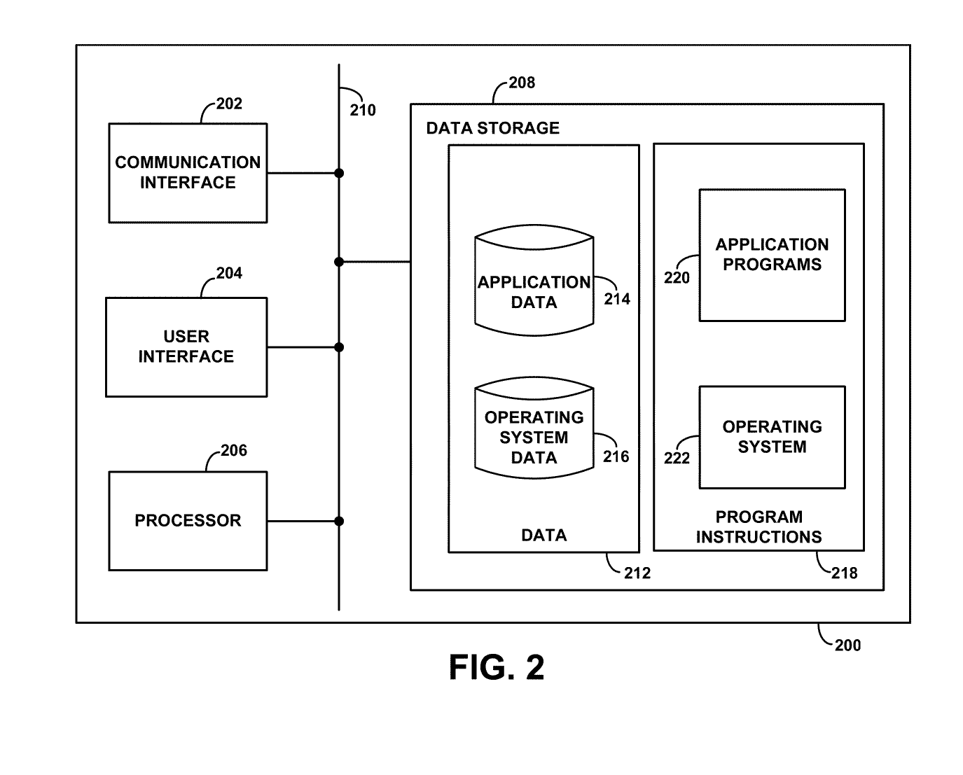

FIG. 2 is a simplified block diagram showing some of the components of an example computing device 200. In some cases, computing device 200 may be referred to as a client device or a user device.

By way of example and without limitation, computing device 200 may be a “plain old telephone system” (POTS) telephone, a cellular mobile telephone, a still camera, a video camera, a fax machine, an answering machine, a computer (such as a desktop, notebook, or tablet computer), a personal digital assistant (PDA), a home automation component, a digital video recorder (DVR), a digital TV, a remote control, or some other type of device equipped with one or more wireless or wired communication interfaces.

As shown in FIG. 2, computing device 200 may include a communication interface 202, a user interface 204, a processor 206, and data storage 208, all of which may be communicatively linked together by a system bus, network, or other connection mechanism 210.

Communication interface 202 functions to allow computing device 200 to communicate, using analog or digital modulation, with other devices, access networks, and/or transport networks. Thus, communication interface 202 may facilitate circuit-switched and/or packet-switched communication, such as POTS communication and/or IP or other packetized communication. For instance, communication interface 202 may include a chipset and antenna arranged for wireless communication with a radio access network or an access point. Also, communication interface 202 may take the form of a wireline interface, such as an Ethernet, Token Ring, or USB port. Communication interface 202 may also take the form of a wireless interface, such as a Wifi, BLUETOOTH®, near-field communication (NFC), global positioning system (GPS), or wide-area wireless interface (e.g., WiMAX or LTE). However, other forms of physical layer interfaces and other types of standard or proprietary communication protocols may be used over communication interface 202. Furthermore, communication interface 202 may comprise multiple physical communication interfaces (e.g., a Wifi interface, a BLUETOOTH® interface, and a wide-area wireless interface).

User interface 204 may function to allow computing device 200 to interact with a human or non-human user, such as to receive input from a user and to provide output to the user. Thus, user interface 204 may include input components such as a keypad, keyboard, touch-sensitive or presence-sensitive panel, computer mouse, trackball, joystick, microphone, still camera and/or video camera. User interface 204 may also include one or more output components such as a display screen (which, for example, may be combined with a presence-sensitive panel), cathode-ray tube (CRT), liquid-crystal display (LCD), light emitting diode (LED) display, a display using digital light processing (DLP®) technology, printer, light bulb, and/or other similar devices, now known or later developed. User interface 204 may also be configured to generate audible output(s), via a speaker, speaker jack, audio output port, audio output device, earphones, and/or other similar devices, now known or later developed. In some embodiments, user interface 204 may include software, circuitry, or another form of logic that can transmit data to and/or receive data from external user input/output devices. Additionally or alternatively, computing device 200 may support remote access from another device, via communication interface 202 or via another physical interface (not shown).

Processor 206 may comprise one or more general purpose processors (e.g., microprocessors) and/or one or more special purpose processors (e.g., digital signal processors (DSPs), graphics processing units (GPUs), floating point units (FPUs), network processors, or application-specific integrated circuits (ASICs)). Data storage 208 may include one or more volatile and/or non-volatile storage components, such as magnetic, optical, flash, or organic storage, and may be integrated in whole or in part with processor 206. Data storage 208 may include removable and/or non-removable components.

Generally speaking, processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing device 200, cause computing device 200 to carry out any of the methods, processes, or functions disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., address book, email, web browsing, social networking, and/or gaming applications) installed on computing device 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing device 200.

Application programs 220 may communicate with operating system 212 through one or more application programming interfaces (APIs). These APIs may facilitate, for instance, application programs 220 reading and/or writing application data 214, transmitting or receiving information via communication interface 202, receiving or displaying information on user interface 204, and so on.

In some vernaculars, application programs 220 may be referred to as “apps” for short. Additionally, application programs 220 may be downloadable to computing device 200 through one or more online application stores or application markets. However, application programs can also be installed on computing device 200 in other ways, such as via a web browser or through a physical interface (e.g., a USB port) on computing device 200.

### 3. Example Client Devices, Tandem Devices, and Communication System

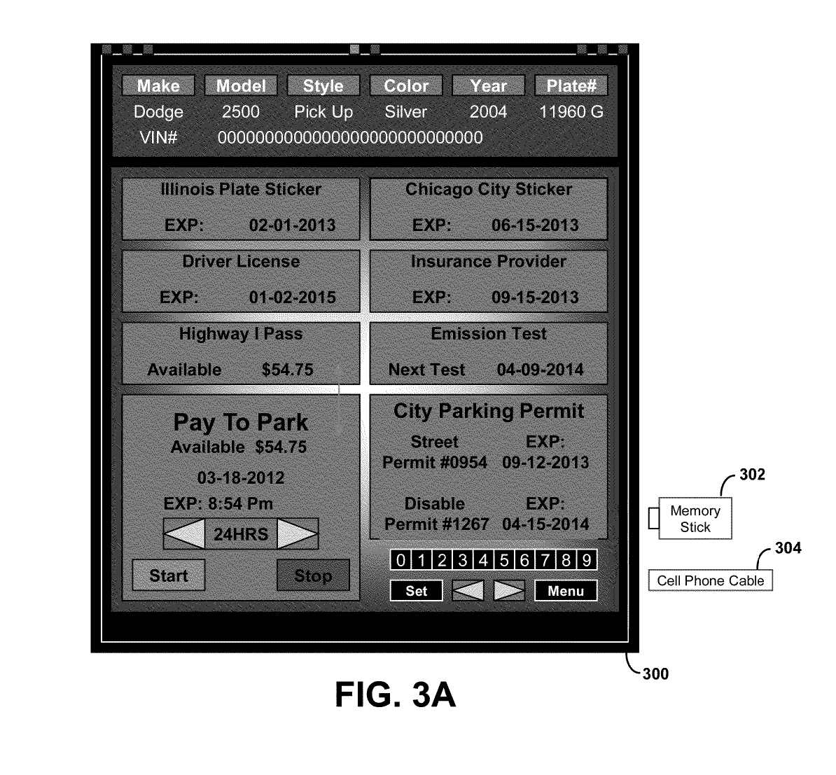

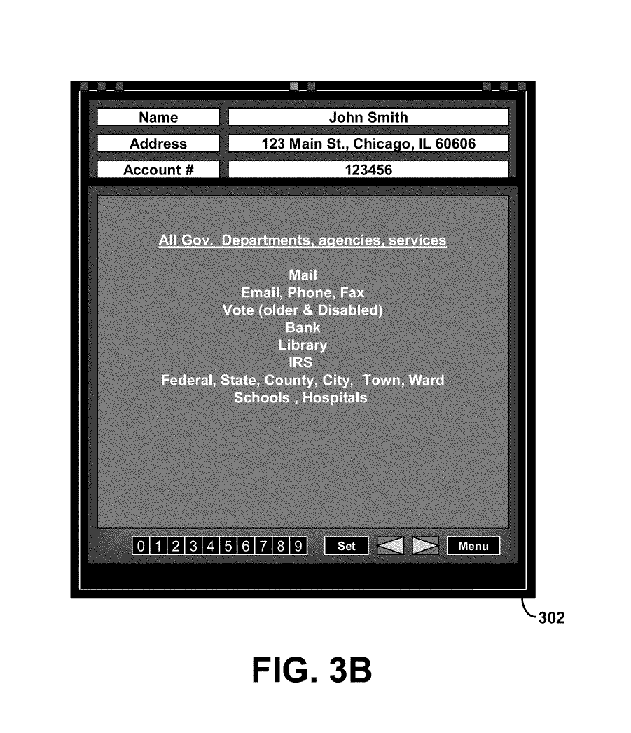

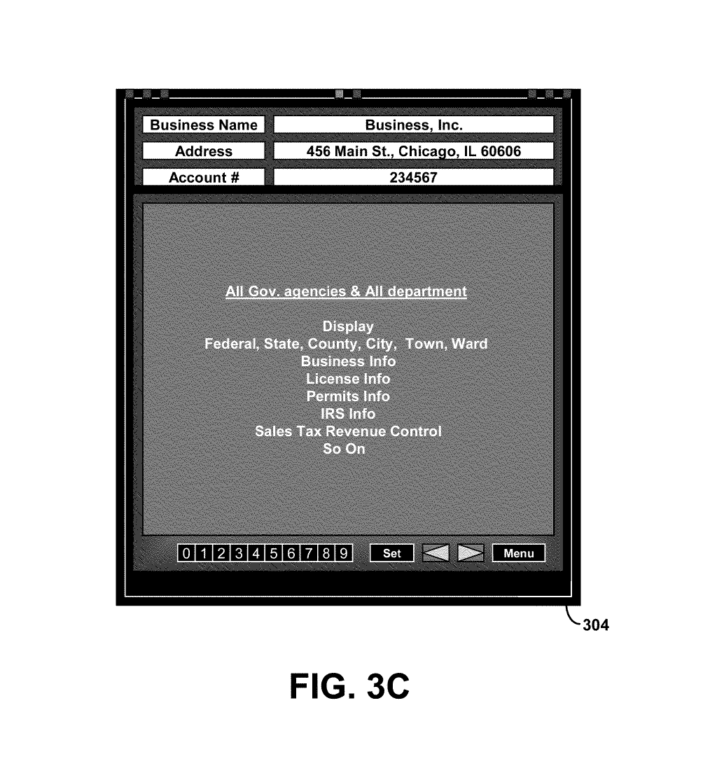

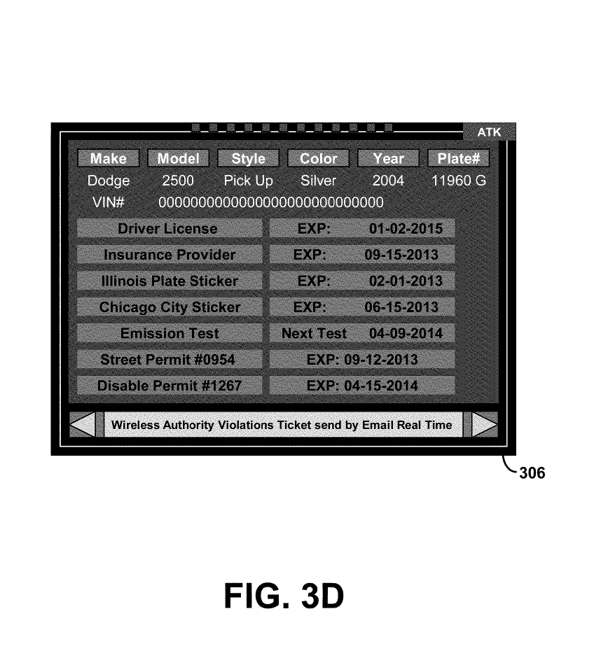

FIGS. 3A, 3B, 3C, and 3D are example hardware designs and user interfaces for supporting various types of personal communication applications and functions. Particularly, these figures illustrate the components and user interface features that may be included in a physical client device 300 operating one or more personal communication applications. In some embodiments, client device 300 may be based on the physical hardware of computing device 200.

Client device 300 of FIG. 3A is shown supporting vehicle registration, highway tolls, and parking applications. However, client device 300 may support other applications and functions as well. These applications may be integrated, in the sense that one software module or program supports vehicle registration, highway toll, and parking functions, or multiple applications may operate in conjunction with one another to provide these functions.

Client device 300 may support vehicle registration by having access to, and the possible ability to display, information about a vehicle, such as the vehicle's make, model, style, color, year, vehicle identification number (VIN), license plate number, state registration sticker (e.g., the “Illinois plate sticker”), insurance information, and emissions testing information. Further, client device 300 may also have access to and display information about the vehicle owner's driver's license and highway toll account (e.g., “Highway I-Pass”).

In addition to this state-level information, city-level information may be supported as well. For example, client device 300 may have access to and display a city registration (e.g., Chicago City Sticker) and a city parking permit. For the city parking permit, information such as the permit number, date of expiration, and whether the vehicle owner is disabled may be included. Additional types of city-level information may be included as well, for instance special permits for certain types of vehicles (e.g., trucks, commercial vehicles, and so on).

Also, client device 300 may have access to and display information related to a parking account. This parking account may be debited for both city and municipal parking and by private parking entities. Thus, the vehicle owner need not establish separate accounts multiple parking providers, and may be able to park in multiple public and private locations without using cash or a credit card for payment.

Moreover, client device 300 may be able to exchange information with other devices through various ports and/or interfaces. For instance, information and/or program instructions may be uploaded to or downloaded from client device 300 via memory stick 302, cell phone cable 304, and/or in a wireless fashion.

Client device 300 may be placed conspicuously in a vehicle, such as on the vehicle's dashboard, so that its registration and account information can be visibly perceived. Alternatively or additionally, client device 300 may be equipped with one or more wireless communication interfaces (e.g., CDMA, LTE®, BLUETOOTH®, Wifi, and/or NFC). Such a device could be read using another device from a short or medium range distance. Thus, client device 300 could be kept conspicuously or hidden in the vehicle, but still operate. Similarly, client device 300 may be kept in a residence, in a business, on one's person, or in other locations.

The latter wireless function may be particularly advantageous, because it can allow law enforcement officers, parking control officers, and private parking employees to validate the registration, ownership, and/or parking status of the vehicle merely by walking, driving, or being nearby the vehicle. Additionally, homeland security functions, such a location tracking, may be facilitated.

The user interface of client device 300 may require user authentication. Thus, before a user is permitted to access information or otherwise use client device 300, client device 300 may prompt the user for their authentication credentials. These credentials may include (but are not limited to) a password, a fingerprint, a retinal scan, and/or some other form of identification.

Client device 302 of FIG. 3B may be used by an individual for communication with government entities. Thus, client device 302 may be similar to client device 300, and may share at least some functions with client device 300, but may be used for different functions.

For instance, client device 302 may include an indication of the individual's name and address. Furthermore, client device 302 may facilitate communication between the individual and any number of governmental entities. The communication may entail communication via telephone, fax, email, various types of multimedia, etc. These governmental entities may include boards of elections, libraries, tax collection agencies, schools, hospitals, and any other federal, state, county, city, town, or ward function.

Client device 304 of FIG. 3C may be used by a business for communication with government entities. Thus, client device 304 may be similar to client device 300 and/or client device 302, and may share at least some functions with client device 300 and/or client device 302, but may be used for different functions.

For instance, client device 304 may include an indication of the business's name and address. Furthermore, client device 304 may facilitate communication between the business and any number of governmental entities. These governmental entities may include tax collection agencies, and any other federal, state, county, city, town, or ward function. Moreover, client device 304 may also be capable of storing and/or displaying information related to the business, including the business's licenses, permits, and so on. In some embodiments, client device 304 may be able to engage in telephony and/or multimedia calls, and send and receive faxes and/or email.

Client device 306 of FIG. 3D may be used by a law enforcement for gathering information regarding vehicles. When brought into proximity with one such vehicle, the client device associated with the vehicle (e.g., client device 300) may exchange secure communications with client device 306 and transmit information related to the vehicle to client device 306. Client device 306 may be similar to client device 300, client device 302, and/or client device 304, and may share at least some functions with client device 300, client device 302, and/or client device 304, but may be used for different functions.

For instance, client device 306 may be may be able to receive, store and/or display information regarding a vehicle, such as the vehicle's make, model, style, color, year, license plate number, and VIN. Additional information may include vehicle owner's driver's license information and insurance provider, as well as the vehicle's state and/or local registrations, emissions test results, and permits. From this information, a law enforcement officer may be able to determine ownership of the vehicle, whether any registrations or permits have expired, and whether the vehicle is parked illegally.

If the law enforcement officer issues a ticket, the ticket may be transmitted electronically to the vehicle's client device, which may alert the vehicle's owner and/or operator. One of those individuals may then, through the vehicle's client device or their own client device, instruct an associated account to be debited for the cost of the ticket. This cost may be credited to an appropriate governmental entity's account. Additionally or alternatively, a notification of the violation may be transmitted to the vehicle owner's individual client device (e.g., client device 302), to the vehicle owner's cell phone (e.g., via email or text message), and so on.

In the following sections, client devices may be referred to, for sake of convenience, as client device 300. However, even if a client device is referred to as client device 300, this client device may incorporate some or all of the functions of any of client devices 302, 304, and/or 306.

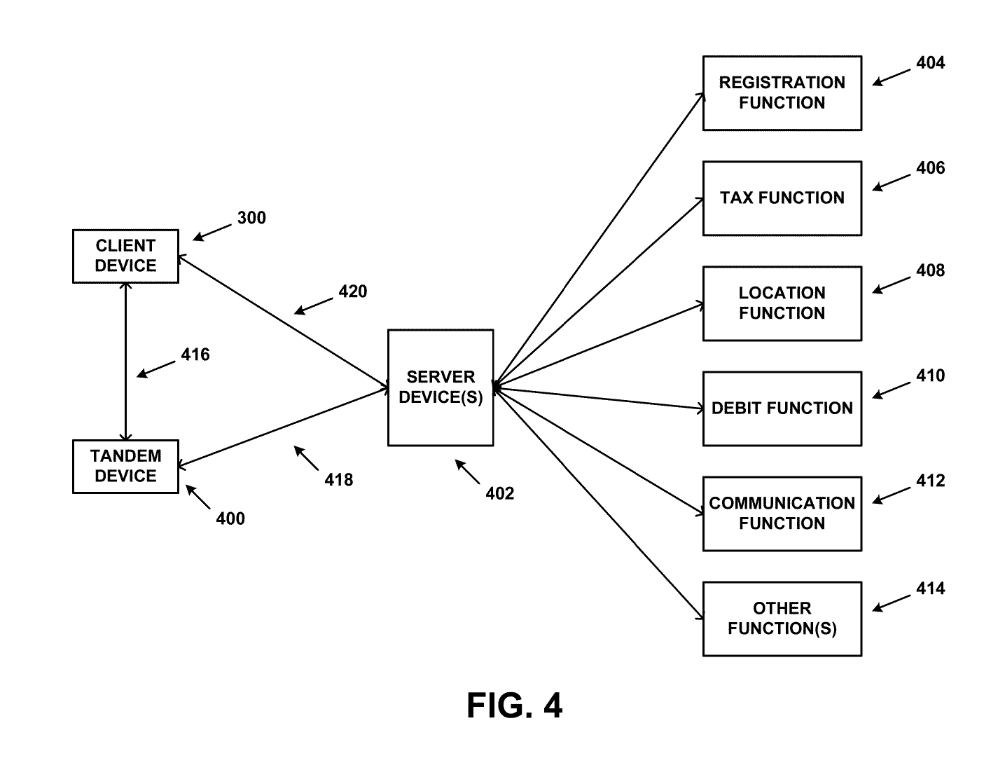

FIG. 4 illustrates an example communication architecture involving client device 300, tandem device 400, and server device(s) 402. In some scenarios, client device 300 and tandem device 400 may be located proximate to one another (e.g., within a few meters or a few dozen meters of one another) or more distant from one another, and may be able to communicate directly with one another via e.g., wireless technologies such as BLUETOOTH®, NFC, Wifi, etc., via link 416. In these scenarios, client device 300 may communicate through tandem device 400 to server device(s) 402 via links 416 and 418. On the other hand, client device 300 may communicate with server device(s) 402 via link 420. Any of links 416, 418, and 420 may be wireless, wireline or both.

Server device(s) 402 may be located remotely from client device 300 and tandem device 400. For instance, server device(s) 402 may be part of a data center or server cluster spread across one or more physical locations. Also, server device(s) 402 may be hosted, operated, and/or controlled by one or more governmental entities, governmental contractors and/or other types of entity.

Server device(s) 402 may include or have access to multiple specialized functions, such as registration function 404, tax function 406, location function 408, debit function 410, communication function 412, and/or other functions 414 as well. Each of these functions may be hosted, operated, and/or controlled by an entity that hosts, operates, and/or controls server device(s) 402, or by some other entity.

Registration function 404 may facilitate client device 300 in accessing one or more registrations. Each registration may be between an individual or business associated with client device 300 and a particular entity, and may define the relationship between those parties. Examples of registrations include identifications (e.g., licenses, identification cards, etc.), memberships, voting registrations, taxation registrations, parking permits, and so on.

Tax function 406 may facilitate client device 300 in accessing one or more tax assessment or collection entities. These entities may include federal entities (e.g., the U.S. Internal Revenue Service), state entities, county entities, city entities, and so on. Through tax function 406, an individual or business may receive tax bills and/or assessments. Further, client device 300 may facilitate the automatic or semi-automatic reporting of personal and business income to these tax entities, as well as the payment of associated taxes.

Location function 408 may facilitate tracking the location of client device 300, and may provide tracked locations to various other entities. For instance, the location of client device 300 may be used in conjunction with revenue collection (e.g., toll and parking fee payment), and/or law enforcement. Thus, location function 408 may also facilitate homeland security procedures.

Debit function 410 may facilitate relating client device 300 (and/or an individual or business associated with client device 300) to a debit account. The debit account may be funded with an amount of currency, and therefore may carry a balance. Alternatively or additionally, the debit account may be linked to a bank account, credit card, debit card, etc., and therefore may debit and/or credit that account. Debit function 410 may allow client device 300 to be used in place of physical currency, such as paper money or coins, for various functions.

Communication function 412 may facilitate communication between client device 300 and other entities. Particularly, some of these entities may be various governmental entities that provide notifications, information, bills, and so on to an individual or business associated with client device 300. This communication may take the form of, or be similar to email, text messaging, instant messaging, or some other form of electronic communication.

Other function(s) 414 represents one or more additional functions not explicitly described herein. The system illustrated by FIG. 4, and described further herein, may be configured to perform a wide variety of functions, some of which may be combined with one or more of the functions disclosed above.

It should be understood that the functions of FIG. 4 may be integrated with one another or may be combined in numerous ways. For example, an individual or business associated with client device 300 may be able to pay taxes via client device 300 and two or more of registration function 404, tax function 406, debit function 410, and communication function 412. Other such integrations are possible. Additionally, more or fewer functions may be present, and multiple instances of some functions may be included.

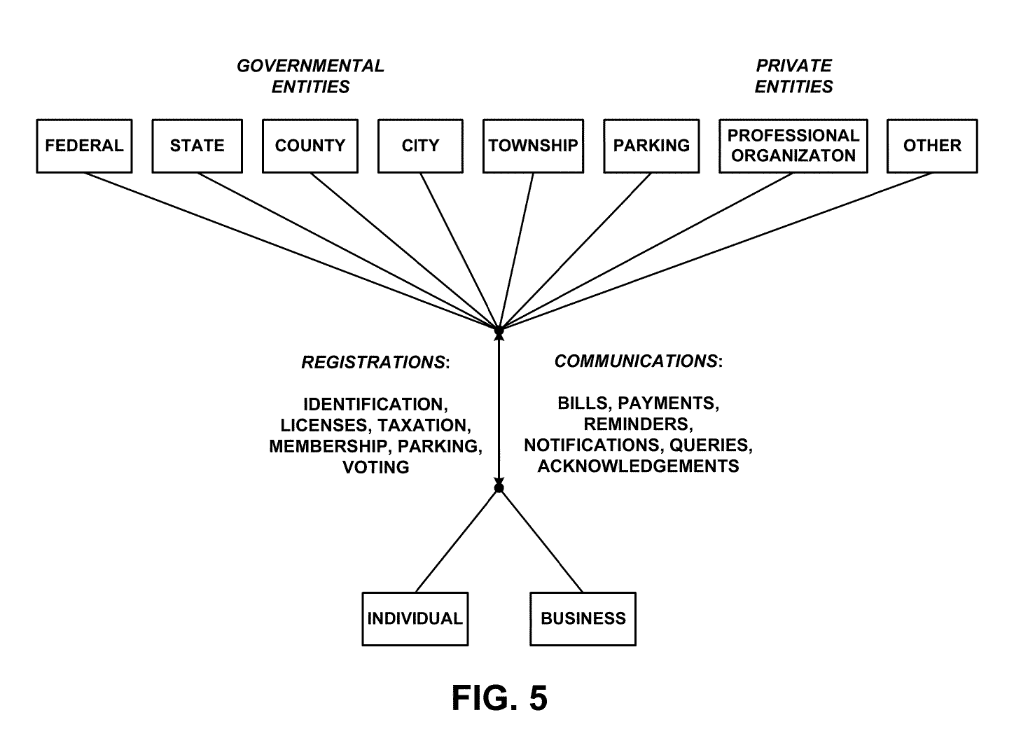

FIG. 5 illustrates example use cases for personal communication applications. An individual or a business may communicate with various government entities. Some of these entities include federal (e.g., the Internal Revenue Service, and the Department of Homeland Security, etc.), state (e.g., department of motor vehicles, secretary of state, and department of revenue functions, etc.), county (e.g., property tax, animal control, public works, and transportation functions, etc.), city (e.g., tax, sales tax, parking control, business relations, water, gas, and sewage functions, etc.), and township (e.g., senior services and marriage licensing functions, etc.) agencies and bodies.

Similarly, individuals and businesses may also communicate with various private entities, including private parking entities, professional organizations, and any other non-governmental body with which an individual or business may have a relationship.

With these governmental or private entities, the individual or business may have a number of registrations. Each of these registrations may result in various types of information being exchanged between the individual or business and the entity. These communications may include bills, payments, notifications, reminders, queries, acknowledgements, and so on.

For some individuals and businesses, the volume of these communications may be significant. The individual or business may receive various mailings, faxes, emails, and so on, each entity potentially using a different format for the information contained therein. Further, the individual or business may be required to fill out and file various forms with the entity. However, in many cases, communications from an entity to an individual or business may be purely informational, and perhaps unnecessary. Thus, these communications, if in paper form, may not be environmentally conscious, and their magnitude may frustrate the recipient.

Moreover, some of the information that the individual or business may share with two or more entities may be duplicative. For instance, many individuals and businesses pay both a federal income tax and a state income tax. In many cases, the basic information that both the federal and state tax entities receive is the same. Thus, it may be beneficial for the individual or business to only have to provide this information one time, and then allow the federal and state tax entities to access this information as needed.

In order to facilitate consolidating the communications and information depicted in FIG. 5, one or more personal communication applications may be used. Each of these applications may include software that operates on various types of client devices, such as wireless communication devices, tablet computers, and/or desktop computers. Alternatively or additionally, these applications may operate on dedicated or partially dedicated hardware devices (e.g., computing device 200 and/or client device 300) that may be arranged to support some of the specific features of personal communication applications.

The physical client devices and/or the personal communication applications that can operate thereon may be provided to individuals, businesses, and other entities by a governmental entity or a private entity.

### 4. Example Transactions

The arrangements of FIGS. 1-5 may be employed in various ways to facilitate various types of transactions. Some examples of supported transactions are provided in the subsections below. However, it should be understood that these examples are non-limiting, and other example transactions may be supported.

A. Vehicle Parking

One possible example embodiment of the use of a personal communication application and/or device is paperless and cashless parking at various parking facilities. (Herein, parking facilities include any entity or location that provides parking, such as indoor or outdoor parking, multi-level parking, underground parking, street parking, etc.) Many current public and private parking mechanisms are inefficient. Some require that the individual parking his or her vehicle provide paper money or coins. However, this mechanism works poorly when the individual is not carrying enough currency, or is required to provide exact change. Additionally, if the money is collected by automated machines, these machines may not accept paper money that is worn or folded in certain ways. Furthermore, exposure to the elements, such as wind, rain, snow, and/or intense sunlight may cause these machines to fail.

Other parking mechanisms require that the individual use his or her credit card to pay for parking. Thus, when entering or leaving the parking facility the individual may provide his or her credit card to an automated machine so that the machine can read and charge the credit card. However, these machines also are subject to failure when exposed to the elements.

Regardless of the type of machine used, the machine may provide the individual with a temporary paper parking permit which he or she may place conspicuously in his or her vehicle. This paper permit may be used to assess the parking fee charged to the individual or to verify that the vehicle's parking fee has been paid. However, after the vehicle leaves the parking facility, the paper permit serves little or no purpose. Thus, paper permits may not be environmentally sound.

In some parking facilities, an individual may pre-register his or her vehicle for parking in the facility. This may involve the individual using a key card, transponder, or some other form of identification to enter and/or leave the parking facility. However, this type of parking mechanism typically only works with a small number of parking facilities, perhaps as little as one. Thus, if the individual wishes to park his or her car in a different public or private parking facility, the individual may have to resort to using cash or a credit card to do so.

Further, some towns, cities, and/or municipalities require payment for parking on certain streets or in certain government parking facilities. For example, some street parking is metered, in that an individual may have to provide paper money or coins to a parking meter associated with a parking space in order to purchase parking time in the space. In some locations, a machine that accepts cash and/or credit cards may replace one or more parking meters. Alternatively or additionally, an individual wishing to park his or her vehicle on a street may have to purchase a sticker from the town, city, or municipality. This sticker may have to be affixed in a particular location on one of the vehicle's windows. If the vehicle parks in several locations, a different sticker for each location may be required.

It may be beneficial to consolidate or unify parking mechanisms. For instance, today's disparate parking mechanisms may require an individual who wishes to park in various locations to carry cash, a credit card, a parking sticker, and perhaps some other form of currency or identification. Instead of or in place of some or all of these mechanisms, a client device such as client device 300 may be used.

As noted above, client device 300 may contain, have access to, and/or be able to display information that identifies a vehicle, such as the vehicle's make, model, style, color, year, vehicle identification number, license plate number, state registration sticker, and so on. Additionally, client device 300 may also be associated with an account from which funds can be electronically debited.

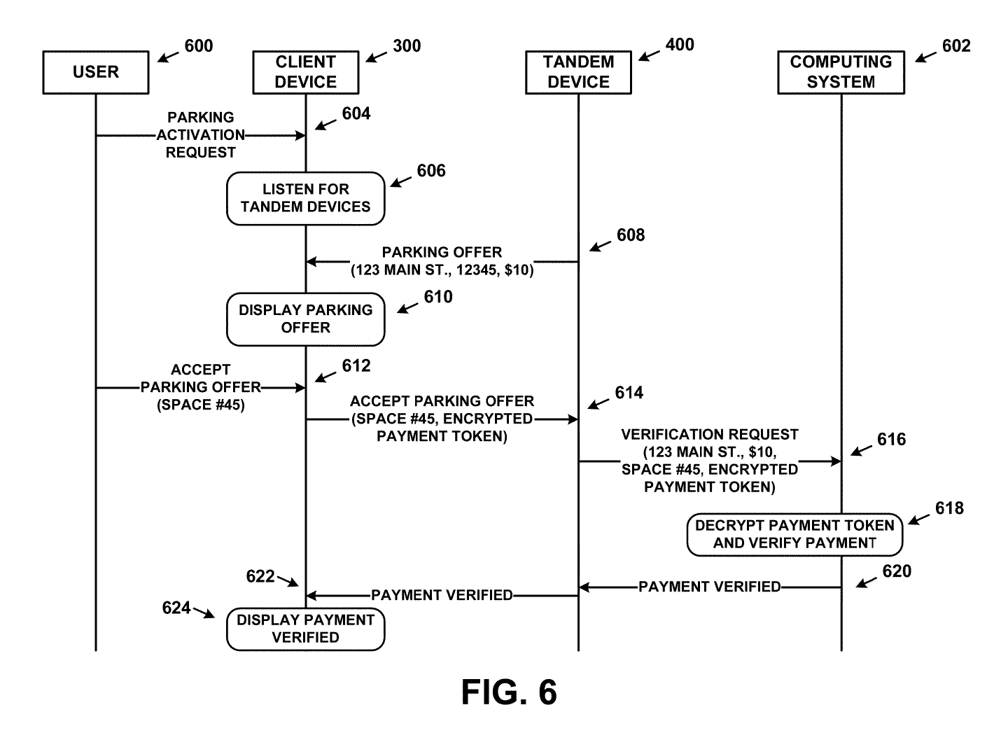

FIG. 6 is a message flow depicting an example embodiment. This embodiment involves user 600 using client device 300 to pay for parking at a parking facility associated with tandem device 400. In order to facilitate payment, it is assumed that user 600 has established an account on computing system 602, from which a parking fee can be debited. Computing system 602 may include server device(s) 402 and one or more of the functions of FIG. 4. Server device(s) 402 may be similar to or contain aspects of server device 110 and/or server data storage 112. The names of the messages and steps of FIG. 6 are for purposes of convenience, and other names may be used instead.

At step 604, user 600 may configure client device 300 with a parking activation request. This request may involve user 600 manipulating the user interface of client device 300 to place client device 300 in a mode in which client device 300 scans various wireless frequencies and/or communication protocols for signals from one or more tandem devices. Thus, at step 606, client device 300 listens for tandem devices.

At step 608, client device may receive a parking offer from tandem device 400. Tandem device 400 may be configured to periodically, or from time to time, transmit or broadcast parking offers on various wireless frequencies and/or wireless protocols. These parking offers may specify a location of the parking facility (e.g., 123 Main St., in zip code 12345) and the fees for parking at the parking facility (e.g., $10). In some cases, tandem device may 400 transmit multiple parking offers, some for different locations and/or for different prices).

At step 610, client device 300 may display a representation of the parking offer. For example, client device 300 may display a dialog box that contains the text string “Parking offer from 123 Main St. Purchase parking for $10?” along with a “yes” button and a “no” button. In some embodiments in which the parking fee is based on the amount of time the vehicle is parked at the location, the start and stop times of the parking duration may be recorded. Thus, the parking fee may be associated with a limited term. For instance, the $10 fee above may be for one hour of parking.

At step 612, user 600 may indicate acceptance of the offer. For the dialog box example, this may involve user 600 selecting the “yes” button. Additionally, user 600 may indicate a parking space in which he or she intends to park or has parked (e.g., space #45).

Possibly in response to the offer being accepted, at step 614, client device 300 may transmit an accept parking offer message to tandem device 400. This message may include an indication of the sparking space, as well as an encrypted payment token. The encrypted payment token may indicate a payment of the parking fee (e.g., $10) from an account associated with client device 300 to an account associated with tandem device 400. The encryption may be based on a symmetric encryption algorithm using a key that is pre-shared between client device 300 and computing system 602. Alternatively, the payment token may not be encrypted.

At step 616, perhaps in response to receiving the accept parking offer, tandem device 400 may transmit a verification request to computing system 602. The verification request may include indications of the location associated with tandem device 400, the parking fee, the parking space, and/or the encrypted payment token.

In some embodiments, the parking space may be omitted from the communications of steps 612, 614, and 616. Alternatively or additionally, vehicle identification information (e.g., some or all of the information shown on client device 300 in FIG. 3) may be transmitted to tandem device 400 and/or computing system 602. Thus, for example, tandem device 400 and/or computing system 602 may record one or more of the vehicle's make, model, style, color, year, VIN, license plate number, insurer, registrations, and so on. In some implementations, a smaller number of one or more vehicle identifiers may be transmitted to tandem device 400 and/or computing system 602, and then tandem device 400 and/or computing system 602 may look up the remaining identifiers in a database.

At step 618, computing system 602 may decrypt the encrypted payment token and verify the payment. Payment verification may include computing system 602 accessing the account associated with client device 300, determining that the account has a sufficient balance to pay the parking fee, and then debiting the parking fee from the account. This payment verification may be performed, at least in part, by a debit function, such as debit function 410. At step 620, computing system 602 may transmit a payment verified message to tandem device 400, indicating that client device 300 has successfully paid the parking fee.

Perhaps in response to receiving the payment verified message of step 620, at step 622, tandem device 400 may transmit the payment verified message to client device 300. Alternatively, the payment verified message of step 622 may be formatted differently from the payment verified message of step 620. Potentially as a result of receiving the payment verified message of step 622, at step 624 client device 300 may display a payment verified indication.

B. Gas Station Transactions

Another possible example embodiment of the use of a personal communication application is paperless and cashless gas station transactions. (Herein, a gas station transaction includes any type of transaction that facilitates the fueling or charging a vehicle for future use, including pumping gasoline into a tank of the vehicle, charging electrical components of the vehicle, etc.)

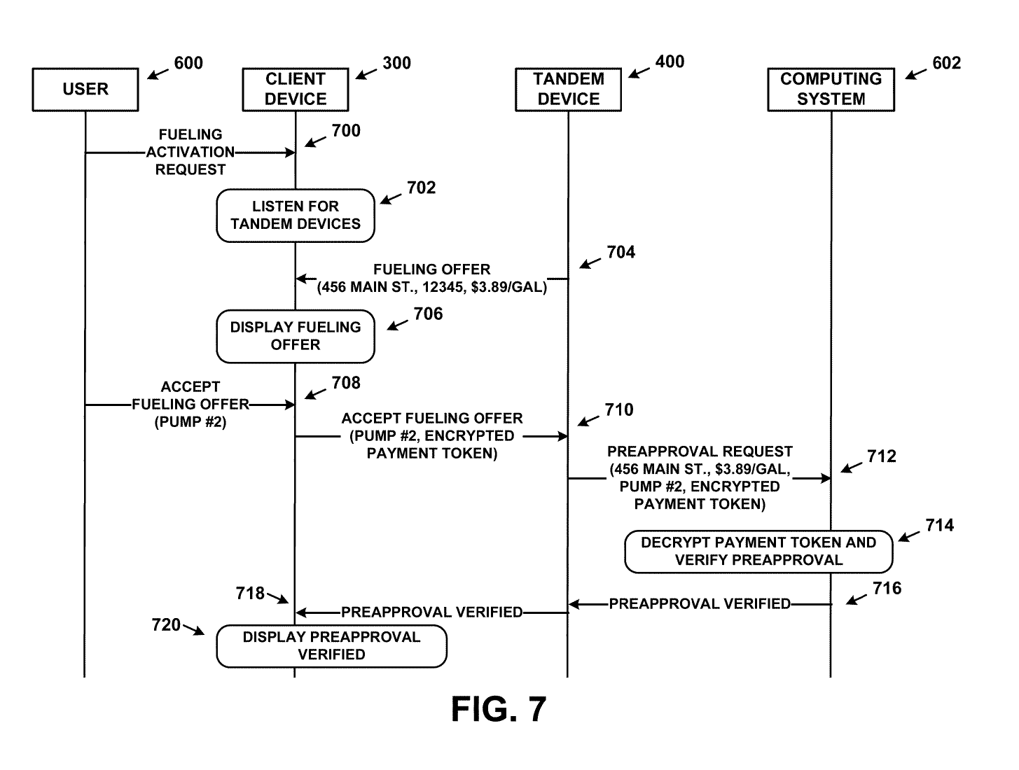

FIG. 7 is a message flow depicting an example embodiment. This embodiment involves user 600 using client device 300 to pay for fueling at a gas station associated with tandem device 400. It should be noted that the message flow of FIG. 7 is similar to the message flow of FIG. 6. However, even though the same reference numerals are used to designate user 600, client device 300, tandem device 400, and computing device 602, it should not be assumed that the same devices are required for the message flow of FIGS. 6 and 7. Thus, for example, the message flow of FIG. 7 may use completely different devices than the message flow of FIG. 6.

As was the case of the message flow of FIG. 6, user 600 may have established an account on computing system 602, from which feuling fees can be debited. Additionally, the names of the messages and steps of FIG. 7 are for purposes of convenience, and other names may be used instead.

At step 700, user 600 may configure client device 300 with a fueling activation request. This request may involve user 600 manipulating the user interface of client device 300 to place client device 300 in a mode in which client device 300 scans various wireless frequencies and/or communication protocols for signals from one or more tandem devices. Thus, at step 702, client device 300 listens for tandem devices.

At step 704, client device 300 may receive a fueling offer from tandem device 400. Tandem device 400 may be configured to periodically, or from time to time, transmit or broadcast fueling offers on various wireless frequencies and/or wireless protocols. These fueling offers may specify a location of the gas station (e.g., 456 Main St., in zip code 12345) and the fees for fueling at the gas station (e.g., $3.89 per gallon of gasoline). In some cases, tandem device 400 may transmit multiple fueling offers, some for different locations and/or for different prices).

At step 706, client device 300 may display a representation of the fueling offer. For example, client device 300 may display a dialog box that contains the text string “Fueling offer from 456 Main St. Purchase fuel for $3.89/gallon?” along with a “yes” button and a “no” button.

At step 708, user 600 may indicate acceptance of the offer. For the dialog box example, this may involve user 600 selecting the “yes” button. Additionally, user 600 may indicate a pump number in which he or she intends to fuel his or her vehicle (e.g., pump #2).

Possibly in response to the offer being accepted, at step 710 client device 300 may transmit an accept fueling offer message to tandem device 400. This message may include an indication of the pump number, as well as an encrypted payment token. The encrypted payment token may identify an account associated with client device 300. The encryption may be based on a symmetric encryption algorithm using a key that is pre-shared between client device 300 and computing system 602.

At step 712, perhaps in response to receiving the accept fueling offer, tandem device 400 may transmit a preapproval request to computing system 602. The preapproval request may seek to verify that user 600 has sufficient credit in his or her account to pay for fueling. The preapproval request may include indications of the location associated with tandem device 400, the pump number, the fueling fee (e.g., $3.89/gallon), and/or the encrypted payment token. In some embodiments, the pump number may be omitted from the communications of steps 708, 710, and 712.

At step 714, computing system 602 may decrypt the encrypted payment token and verify the preapproval request. This verification may include computing system 602 accessing the account associated with client device 300, and determining that the account has a sufficient balance to pay a reasonable fueling fee (e.g., the account has a balance of $100.00 or more). This payment verification may be performed, at least in part, by a debit function, such as debit function 410. At step 716, computing system 602 may transmit a preapproval verified message to tandem device 400, indicating that client device 300 has successfully been preapproved to pay the fueling fees.

Perhaps in response to receiving the preapproval verified message of step 716, at step 718, tandem device 400 may transmit the preapproval verified message to client device 300. Potentially as a result of receiving the preapproval verified message of step 718, at step 720 client device 300 may display a preapproval verified indication.

After step 720, and not shown in FIG. 7, user 600 may fuel his or her vehicle. After fueling is complete, tandem device 400 may determine the total fueling charge (e.g., the number of gallons pumped times the price per gallon) and transmit this information in a payment request message to computing system 602. The total fueling charge may also be transmitted to and displayed on client device 300. Computing system 602 may then debit the account associated with client device 300 by the total fueling change, and credit the account associated with tandem device 400 with at least part of the total fueling charge.

It should be appreciated that the transactions of FIGS. 6 and 7 provide examples of the types of transactions that the embodiments herein may support. Additional types of transactions may be possible.

C. Tolling Transactions

In addition to parking and fueling transactions, client device 300 may also facilitate road and highway toll collection transactions, as well as traffic metering (e.g., counting vehicles) that use particular streets and highways. Modern tolling systems support “open road tolling,” for which a vehicle does not need to stop to be assessed a toll. To use these systems, a vehicle may carry a transponder that communicates wirelessly with a tolling device. The tolling device may be placed on, adjacent to, or above the road or highway. When the car passes through the tolling system the transponder may identify, to the tolling device, an account to debit the cost of the toll, and the tolling device may facilitate the debiting of this account.

Using the system of FIG. 4, tolling transactions can be supported. For instance, client device 300 might replace the transponder, tandem device 400 might replace the tolling device, and debit function 410 might replace or access the account. In some embodiments, a single account may be used for both parking and tolling.

For tolling transactions, payment of tolling fees may be automatically approved by the client device, without requiring interaction with a user. In this way, open road tolling scenarios can be supported.

D. Vehicle Verification

In addition to vehicle parking, gas station transactions, and tolling transactions, various types of public and/or private entities may wish to verify the identification and ownership of a vehicle, and if the vehicle is parked, whether the vehicle is permitted to park in its current location.

For example, owners and/or operators of a parking facility may periodically audit the vehicles parked in the facility. They may wish to verify that each parked vehicle has purchased an appropriate term of parking from the facility (e.g., using the transaction of FIG. 6), this term has not expired, and the parked vehicle matches the characteristics of the vehicle that purchased the parking. In the latter case, the owners and/or operators may want to avoid letting one individual purchase parking for his or her vehicle, then share the purchased parking with other individuals.

Thus, the owners and/or operators of the parking facility may have, or have access to, one or more verification devices. Each verification device may be of a similar design as client device 300, or may be an application that is configured to operate on a more generic type of client device (e.g., a wireless communication device, tablet computer, etc.).

The verification device may query one or more tandem devices in the parking facility. This query may involve communicating wirelessly or via a physical wireline link with the tandem device(s). From the tandem devices, the verification device may receive information regarding (1) each parking transaction that occurred over a period of time (e.g., all parking transactions that took place in the last 6 hours), (2) whether the term (e.g., duration) associated with each parking transaction is still valid or has expired, (3) a description of each vehicle associated with a paid parking fee (e.g., the vehicle's make, model, color, license plate number, VIN etc.), and/or (4) a space in which each vehicle associated with a paid parking fee is parked.

The verification device may be capable of displaying this information sorted by any of the above fields. Thus, for instance, the verification device may display the information above for each parking space, sorted by parking space number. Therefore, an operator and/or owner of the parking facility can traverse the extent of the facility to determine whether any vehicles parked therein are doing so without having paid for the privilege.

Alternatively or additionally, a tandem device and/or computing system can be configured to automatically detect when a parking term has expired and transmit an alert to a verification device. In this way, the operator and/or owner of the parking facility can be made aware that the term has expired.

E. Sales Tax Assessment and Collection

Another possible example embodiment is sales tax assessment and collection, perhaps in an automated fashion. Many business owners routinely collect sales receipts for their business, determine total sales taxes charged over a period of time, and report and/or pay these sales taxes to their federal, state, and/or local government tax agency. The system depicted in FIG. 4 may facilitate the reporting and/or the collection of this sales tax.

For example, in the transaction of FIG. 6, tandem device 400 may record the revenue (e.g., the cost) associated with a parking payment. Tandem device 400 may report this revenue to computing system 602. Computing system 602 may include a tax function, such as tax function 406, and computing system 602 may route the report to this tax function. Thus, the reporting of tax collection may occur automatically, as part of, or in addition to, the transaction of FIG. 6. The transaction of FIG. 7 may also support such reporting to a tax function. This may be a convenience to business owners, as it may obviate the need to manually track and record each sale. Thus, the time and money of business owners and governmental entities may be saved.

Furthermore, actual sales taxes may be debited automatically from the account associated with tandem device 400. Therefore, the labor-intensive aspects of accounting for and paying sales taxes may be decreased.

Additionally, information regarding assessed sales taxes may also be reported to other governmental agencies, such as federal taxation agencies (e.g., the IRS), so that this information can be considered for purposes of tax deductions.

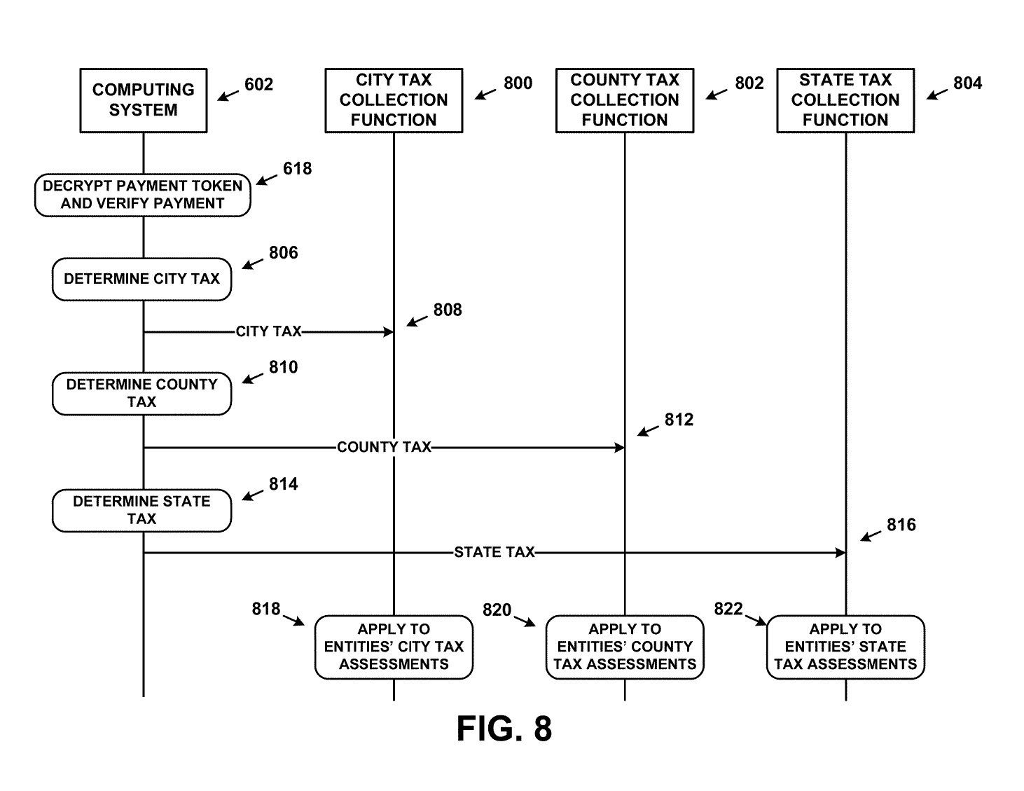

FIG. 8 is a message flow diagram depicting an example embodiment of how a tax function, such as tax function 406, may operate. The transaction of FIG. 8 may be considered to be a stand-alone transaction, or may be part of either or both of the transactions of FIGS. 6 and 7.

For instance, at some point after verifying the payment of step 618 of FIG. 6, computing system 602, at step 806 of FIG. 8, may determine a city tax associated with the payment. At step 808, computing system 602 may transmit a representation of this city tax to city tax collection function 800.

Similarly, at step 810, computing system 602 may determine a county tax associated with the payment. At step 812, computing system 602 may transmit a representation of this county tax to county tax collection function 802. Also, at step 814, computing system 602 may determine a state tax associated with the payment. At step 816, computing system 602 may transmit a representation of this state tax to state tax collection function 804.

In some embodiments only one or two types of taxes may be determined and transmitted to associated tax collection functions. Alternatively, additional taxes, such as federal taxes, import taxes, value added taxes, etc., may be determined and transmitted to associated tax collection functions.

Further, one or more of these taxes may also be recorded as paid in an account associated with the client device. Thus, for example, the user of the client device may be able to apply these paid taxes towards write-offs (or for other purposes) on his or her federal taxes.

It should be understood that this sales tax assessing and collection may be used for more than just parking and fueling transactions. A client device, such as client device 300, may also be used for other transactions, such as purchases of virtually any merchandise, products, or services. If a sales tax is associated with any of these purchases, either a tandem device (such as tandem device 400) or client device 300 may transmit the sales tax information and/or payments to a tax function. In turn, the tax function may transmit some or all of the sales tax information to various governmental agencies.

F. Location Tracking and Security

Current local, regional, and federal safety and security procedures may rely, to some extent, on being able to track the location of individuals and/or vehicles. However, tracking the locations of an individual or vehicle over a period of time may be challenging. For instance, law enforcement may piece together the locations of the vehicle from a combination of public and private security camera images, parking transactions, tolling transactions, word of mouth, and so on.

Using the system of FIG. 4, many (perhaps all) transactions associated with a vehicle can be recorded by location function 408. For example, after a parking transaction occurs, information associated with the parking transaction (e.g., the street address of the parking facility, the parking space, the time of the transaction, the duration of parking that was purchased, and so on), may be transmitted to location function 408. Similarly, information about the locations of tolling transactions, as well as purchases and other transactions, may be stored at location function 408.

Thus location function 408 may include a comprehensive series of locations that a particular vehicle or individual visited. From this information, a timeline of the vehicle's or individual's movements can be determined. This, in turn, may assist law enforcement investigations, suspect tracking, and other forms of location monitoring. Further, this location tracking may also assist the owner of a vehicle, in that a stolen vehicle may be able to be tracked and located.

### 5. Example Embodiments

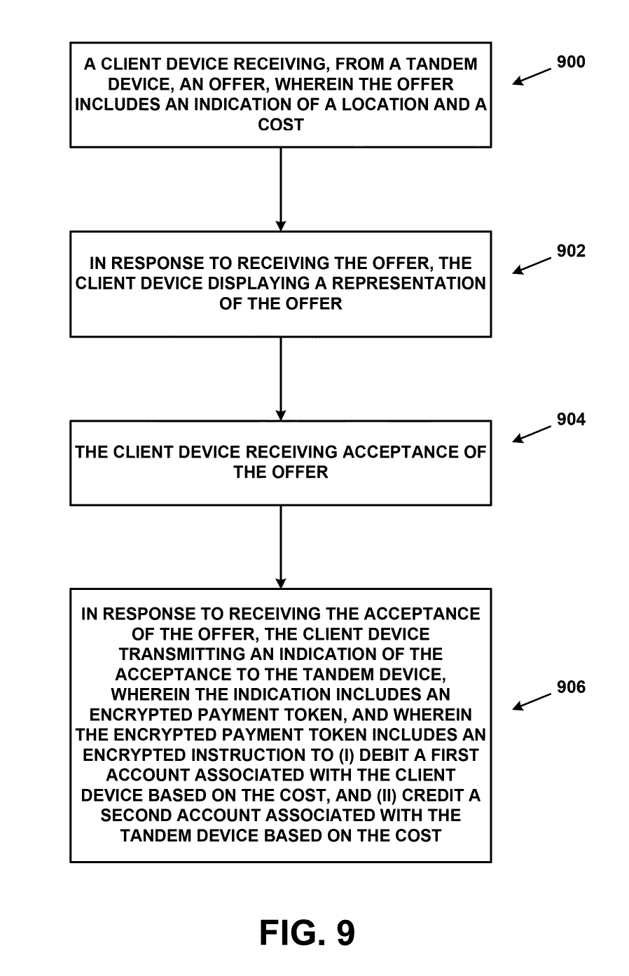

FIGS. 9, 10, and 11 are flow charts that depict example embodiments. One or more steps of these example embodiments may be carried out by a client device, such as client device 300, a tandem device, such as tandem device 400, and/or a computing system, such as computing system 602. Other devices and/or systems may also be involved.

At step 900 of FIG. 9, a client device may receive an offer from a tandem device. The offer may include an indication of a location and a cost.

In some scenarios, the offer may be an offer to facilitate parking a vehicle associated with the client device. The location may be a parking facility, the cost may be associated with parking the vehicle at the parking facility, and the acceptance of the offer may identify a space in the parking facility. In other scenarios, the offer may be an offer to facilitate the purchase of fuel at a fueling facility, the location may be of the fueling facility, the cost may be of a unit of fuel at the fueling facility. Then, the acceptance of the offer may identify a pump at the fueling facility.

Regardless, the client device may be configured to be able to display (i) the make, model and year of the vehicle, (ii) a license plate number of the vehicle, and (iii) a registration status of the vehicle. The client device may display other information as well.

At step 902, possibly in response to receiving the offer, the client device may display a representation of the offer. At step 904, the client device may receive acceptance of the offer.

At step 906, possibly in response to receiving the acceptance of the offer, the client device may transmit an indication of the acceptance to the tandem device. The indication may include an encrypted payment token, and the encrypted payment token may include an encrypted instruction to (i) debit a first account associated with the client device based on the cost, and (ii) credit a second account associated with the tandem device based on the cost.

In some cases, the second account may be credited for an amount that is less than the cost. Further, the amount may be a service cost for a service associated with the acceptance of the offer. A difference between the cost and the amount may include a tax cost for a tax associated with the acceptance of the offer.

Additionally, the first account and the second account may be accessible to a computing system. The computing system may debit the first account and credit the second account. For instance, the computing system may debit the first account by the cost, credit the second account by the service cost, and transmit at least one tax cost to at least one governmental entity.

In some implementations, the client device and the tandem device may communicate via a wireless link. The tandem device and the computing device may communicate via one or more wireline links, and the client device may communicate with the computing system via the tandem device.

Additionally, the client device may receive a payment verification message. The payment verification message may include an indication that (i) the first account has been debited by the cost, and (ii) the second account has been credited based on the cost. In response to receiving the payment verification message, the client device may display an indication that the payment of the cost has been verified.

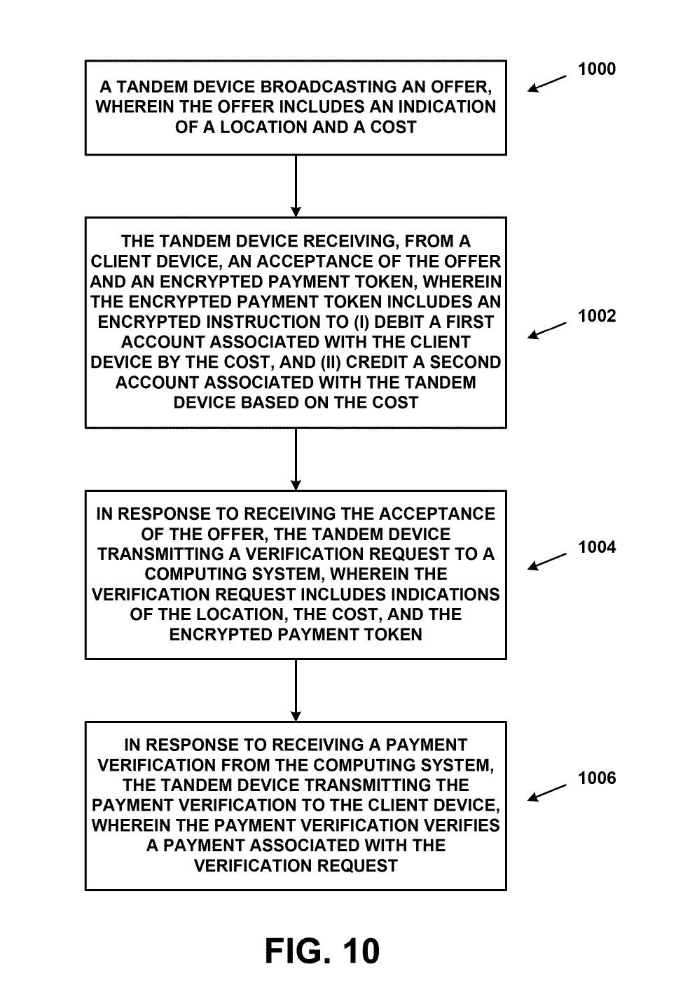

At step 1000 of FIG. 10, a tandem device may broadcast an offer. The offer may include an indication of a location and a cost.

At step 1002, the tandem device may receive, from a client device, an acceptance of the offer and an encrypted payment token. The encrypted payment token may include an encrypted instruction to (i) debit a first account associated with the client device by the cost, and (ii) credit a second account associated with the tandem device based on the cost. The second account may be credited for an amount that is less than cost.

At step 1004, possibly in response to receiving the acceptance of the offer, the tandem device may transmit a verification request to a computing system. The verification request may include indications of the location, the cost, and the encrypted payment token. The computing system may debit the first account and credit the second account.

At step 1006, possibly in response to receiving a payment verification from the computing system, the tandem device may transmit the payment verification to the client device. The payment verification may verify a payment associated with the verification request.

Further, the tandem device may transmit a tax payment indication to the computing system. The tax payment indication may include a sales tax associated with the acceptance of the offer. The computing system may include the tax payment in a tax deduction calculated for an entity associated with the second account.

The client device and the tandem device may communicate via a wireless link. The tandem device and the computing device may communicate via one or more wireline links. The client device may communicate with the computing system via the tandem device.

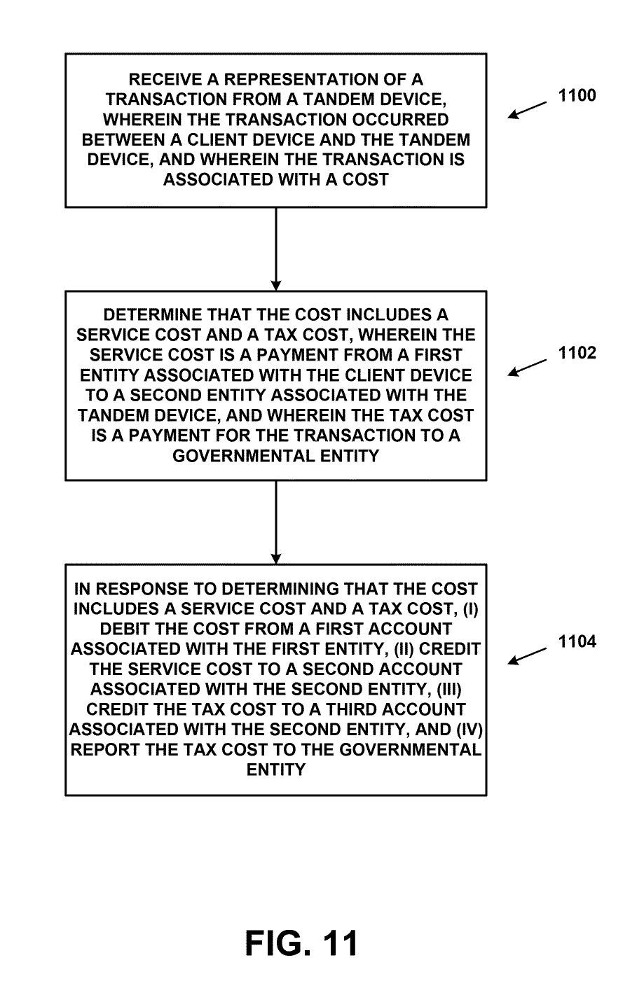

At step 1100 of FIG. 11, a computing system may receive a representation of a transaction from a tandem device. The transaction may have occurred between a client device and the tandem device, and may be associated with a cost.

At step 1102 the computing system may determine that the cost includes a service cost and a tax cost. The service cost may be a payment from a first entity associated with the client device to a second entity associated with the tandem device, and the tax cost may be a payment for the transaction to a first governmental entity.

At step 1104, in response to determining that the cost includes a service cost and a tax cost, the computing system may (i) debit the cost from a first account associated with the first entity, (ii) credit the service cost to a second account associated with the second entity, (iii) credit at least part of the tax cost to a third account associated with the second entity, and (iv) report the credited tax cost to the first governmental entity.

Crediting at least part of the tax cost to a third account associated with the second entity may involve crediting a first part of the tax cost to the third account, and crediting a second part of the tax cost to a fourth account associated with the second entity. Additionally, reporting the credited tax cost to the first governmental entity may involve reporting the first part of the tax cost to the first governmental entity, and reporting the second part of the tax cost to a second governmental entity. In some situations, the first governmental entity may be a state governmental entity and the second governmental entity may be a federal governmental entity.

Regardless, the transaction may have facilitated parking a vehicle associated with the client device at a parking facility associated with the tandem device. Thus, the service cost may be for parking the vehicle at the parking facility, and the tax cost may be a tax on parking the vehicle at the parking facility. Other transactions may also be associated with the flow chart of FIG. 11.

### 6. Additional Features

This section contains descriptions of additional features that may operate in a stand-alone fashion or may be combined with one or more of the other features described herein.

The devices of FIGS. 3A-3D may support one or more alcohol control functions. For instance, client device 300 may have access to or store an age of the vehicle's owner. If the user of client device 300 attempts to use client device 300 to purchase alcohol, client device 300 may check this age against the legal drinking age of the local jurisdiction. If the vehicle owner's age is less than the legal drinking age, client device 300 may prevent the purchase from being completed.

Further, even if the vehicle owner is at least the legal drinking age of the local jurisdiction, client device 300 may prevent more than a certain number of transactions involving the purchase of certain amounts of alcohol from occurring in a particular period of time. For instance, client device 300 may prevent more than two purchases of alcohol per day, more than 20 ounces of a certain type of alcohol per hour, and so on.

Moreover, devices of FIGS. 3A-3D may support blood alcohol level (e.g. breathalyzer) testing. For instance, client device 300 may control whether its associated vehicle can be started. Before allowing the vehicle to be started, client device 300 may require that a user use the device's blood alcohol level test. If the user's blood alcohol level is above a threshold (e.g., 0.08%), client device 300 may prevent the vehicle from being started.

The devices of FIGS. 3A-3D may also support speed control functions. For example, client device 300 may include or have access to GPS technology that allows client device 300 to determine its location. With two or more samples of its location, client device 300 may be able to determine its speed. If the determined speed exceed a threshold rate (e.g., 30 miles per hour, 45 miles per hour, 60 miles per hour, and so on), client device 300 may display and/or sound an alarm signal. The alarm signal may serve to notify a driver of a vehicle that he or she is driving with excessive speed. In some cases, client device 300 may communicate with tandem devices positioned along streets, roads, and highways to determine the posted speed limit, and may dynamically adjust the threshold rate to be in accordance with this limit.

This speed control function may also be used for controlling a user's communications with a client device. As indicated above, any of the client devices may support communication functions such as cellular telephony, text messaging, email, web browsing, and so on. If the client device determines that it is moving beyond a threshold speed (e.g., 2 miles per hour, 5 miles per hour, 10 miles per hour, etc.) it may prevent these communication functions. For instance, the client device may blank its screen, so that the user cannot enter or read any information using the device.

### 7. CONCLUSION

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium, such as a storage device, including a disk drive, a hard drive, or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
a client device receiving an offer from a tandem device, wherein the offer includes an indication of a location and a cost;
in response to receiving the offer, the client device displaying a representation of the offer;
the client device receiving acceptance of the offer; and
in response to receiving the acceptance of the offer, the client device transmitting an indication of the acceptance to the tandem device, wherein the indication includes an encrypted payment token, and wherein the encrypted payment token includes an encrypted instruction to (i) debit a first account associated with the client device based on the cost, and (ii) credit a second account associated with the tandem device based on the cost.

2. The method of claim 1, further comprising:
the client device receiving a payment verification message, wherein the payment verification message includes an indication that (i) the first account has been debited by the cost, and (ii) the second account has been credited based on the cost; and
in response to receiving the payment verification message, the client device displaying an indication that the payment of the cost has been verified.

3. The method of claim 1, wherein the second account is credited for an amount that is less than the cost.

4. The method of claim 3, wherein the amount is a service cost for a service associated with the acceptance of the offer, and wherein a difference between the cost and the amount includes a tax cost for a tax associated with the acceptance of the offer.

5. The method of claim 4, wherein the first account and the second account are accessible to a computing system, wherein the computing system debits the first account and credits the second account, the method further comprising:
the computing system debiting the first account by the cost;
the computing system crediting the second account by the service cost; and
the computing system transmitting the tax cost to a governmental entity.

6. The method of claim 5, wherein the client device and the tandem device communicate via a wireless link, wherein the tandem device and the computing device communicate via one or more wireline links, and wherein the client device communicates with the computing system via the tandem device.

7. The method of claim 1, wherein the offer is an offer to facilitate parking a vehicle associated with the client device, wherein the location is of a parking facility, wherein the cost is of parking the vehicle at the parking facility, and wherein the acceptance of the offer identifies a space in the parking facility.

8. The method of claim 7, wherein the client device is configured to be able to display (i) the make, model and year of the vehicle, (ii) a license plate number of the vehicle, and (iii) a registration status of the vehicle.

9. The method of claim 1, wherein the offer is an offer to facilitate the purchase of fuel at a fueling facility, wherein the location is of the fueling facility, wherein the cost is of a unit of fuel at the fueling facility, and wherein the acceptance of the offer identifies a pump at the fueling facility.

10. A method comprising:
a tandem device broadcasting an offer, wherein the offer includes an indication of a location and a cost;
the tandem device receiving, from a client device, an acceptance of the offer and an encrypted payment token, wherein the encrypted payment token includes an encrypted instruction to (i) debit a first account associated with the client device by the cost, and (ii) credit a second account associated with the tandem device based on the cost;
in response to receiving the acceptance of the offer, the tandem device transmitting a verification request to a computing system, wherein the verification request includes indications of the location, the cost, and the encrypted payment token; and
in response to receiving a payment verification from the computing system, the tandem device transmitting the payment verification to the client device, wherein the payment verification verifies a payment associated with the verification request.

11. The method of claim 10, further comprising:
the tandem device transmitting a tax payment indication to the computing system, wherein the tax payment indication includes a sales tax associated with the acceptance of the offer.

12. The method of claim 11, wherein the computing system includes the tax payment in a tax deduction calculated for an entity associated with the second account.

13. The method of claim 10, wherein the second account is credited for an amount that is less than cost.

14. The method of claim 10, wherein the computing system debits the first account and credits the second account.

15. The method of claim 10, wherein the client device and the tandem device communicate via a wireless link, wherein the tandem device and the computing device communicate via one or more wireline links, and wherein the client device communicates with the computing system via the tandem device.

16. A computing system comprising:
a processor;
data storage; and
program instructions, stored in the data storage, when executed by the processor cause the computing system to perform operations comprising:
receiving a representation of a transaction from a tandem device, wherein the transaction occurred between a client device and the tandem device, and wherein the transaction is associated with a cost;
determining that the cost includes a service cost and a tax cost, wherein the service cost is a payment from a first entity associated with the client device to a second entity associated with the tandem device, and wherein the tax cost is a payment for the transaction to a first governmental entity; and
in response to determining that the cost includes a service cost and a tax cost, (i) debiting the cost from a first account associated with the first entity, (ii) crediting the service cost to a second account associated with the second entity, (iii) crediting at least part of the tax cost to a third account associated with the second entity, and (iv) reporting the credited tax cost to the first governmental entity.

17. The computing system of claim 16, wherein crediting at least part of the tax cost to a third account associated with the second entity comprises:
crediting a first part of the tax cost to the third account; and
crediting a second part of the tax cost to a fourth account associated with the second entity.

18. The computing system of claim 17, wherein reporting the credited tax cost to the first governmental entity comprises:
reporting the first part of the tax cost to the first governmental entity; and
reporting the second part of the tax cost to a second governmental entity.

19. The computing system of claim 18, wherein the first governmental entity is a state governmental entity and the second governmental entity is a federal governmental entity.

20. The computing system of claim 16, wherein the transaction facilitated parking a vehicle associated with the client device at a parking facility associated with the tandem device, wherein the service cost is for parking the vehicle at the parking facility, and wherein the tax cost is a tax on parking the vehicle at the parking facility.
